(19) United States
(12) Patent Application Publication
(10) Pub. No.: US 2026/0107933 A1
(43) Pub. Date: Apr. 23, 2026

(54) Mosquito Catching Device Kit

(71) Applicant: Collin Cima, Garden Ridge, TX (US)

(72) Inventor: Collin Cima, Garden Ridge, TX (US)

(21) Appl. No.: 18/923,327

(22) Filed: Oct. 22, 2024

(51) Int. Cl. A01M 1/08

(52) U.S. Cl. CPC A01M 1/08; A01M 2200/012

(57) ABSTRACT

A kit for converting or removably adapting a conventional household fan into a mosquito catching device for the purpose of drawing mosquitoes into the fan by the rotating movement of the fan blades and onto a removably attached screen affixed to rear side of the fan. Once the mosquitoes are captured onto the screen, they are unable to escape off the screens as motion of the fan blades keep the mosquitoes trapped on the screen. The kit further comprises a LED light to attract the mosquitoes to the household fan.

### FIELD OF INVENTION

A mosquito catching device in the form of a kit comprising a screen which is removably attached to a conventional motorized household fan and an LED light which can be affixed to the rear side of the fan.

### BACKGROUND OF THE INVENTION

Mosquitoes and other weak flying insects are inherent problems in the enjoyment of the outdoors, such as backyards, decks, porches, and gardens. The bite of a mosquito can be painful and frequently, an individual can be the victim of multiple mosquito bites. And, mosquitoes are known for carrying and transmitting a variety of diseases, including lethal diseases. Thus, there has been an endless effort to treat these flying insects in the attempt to reduce their populations. The most common approach to manage these insects is by chemical treatment, such as the spraying of an outdoor area with a chemical insecticide which either kills the insects within that specific area, or creates a barrier. Another very common chemical treatment is the application of an insect repellant onto an individual's skin. In other instances, electrical devices have been created to “zap” and kill these insects.

### PRIOR ART

The prior art is replete with chemical insecticides formulations and electric zapping devices to manage, control and kill flying insects. One of the many devices that have been developed is the use of a household fan to attract and kill small flying insects, particularly mosquitoes. For example, U.S. Pat. No. 2,883,790 to Blackman discloses a conventional oscillating electric fan having a motor to which is secured the hub of a fan blade having an electric light rearwardly of the fan blade assembly to attract insects and a concentric hood which overlies the light bulb having a crescent-shaped closure member. U.S. Pat. No. 4,443,965 to Gie is directed to a mosquito killer having a motorized suction fan for drawing insects into the housing, a screen member covering the rear opening of the housing and a scraping bar mounted on a rotating shaft in sliding contact with the interior side of the screen member which will crush the insects when rotated.

U.S. Pat. No. 4,819,370 to Woodruff relates to a flying insect eliminator comprising a fan which blows air and insects in the direction of a screen, a flexible monofilament rotates adjacent the screen on the opposite side of the fan, lights within the box attracts insects. The rotating monofilament kills the insects and sweeps them into circular gutters. U.S. Pat. No. 5,157,865 to Chang provides an elaborate cantilever type mosquito catcher installed on a cantilever secured above a fan, a mosquito-attracting agent which is placed on the catcher for luring mosquitoes flying to the lamp to suck the mosquitoes by the fan impeller into a cone shaped net which are killed when they impact against the net. The net may be in the form of a screen.

U.S. Pat. No. 6,077,039 to Hsu relates to an apparatus having a motorized fan with a screen type element having securing pieces affixed on a periphery thereof and affixed to an outer housing thereof such that the screen type element is disposed on one side of the fan blades, a light which induces the mosquitoes to the apparatus and provides an electric shock function for catching the mosquitoes. U.S. Pat. No. 11,102,971 to Ko et al described the use of a UV LED light in combination with a motorized fan for sucking and capturing attracted insects which are an insect net installed in a discharge area. Wall mounted.

### SUMMARY OF THE INVENTION

The invention of the present subject matter relates to kit for adapting a conventional household fan into a mosquito capturing device, the kit comprising a screen element, a screen attachment element, and an LED light source attachable to the motorized fan.

Accordingly, it is an object of the present subject matter to provide kit which can be used to adapt a conventional motorized household fan into a mosquito capturing device.

It is another object of the present subject matter to provide kit for adapting a conventional household fan into a mosquito capturing device comprising a screen which is configured to be removably affixed to the rear side of the household fan.

It is still another object of the present subject matter to provide a kit for adapting a conventional household fan having a metal outer housing into a mosquito capturing device comprising a screen which is removably attachable to the rear side of the fan by a magnet ring, magnetic strips, or a plurality of magnetic pieces secured to the screen.

It is a yet another object of the present subject matter to provide a kit for adapting a conventional household fan into a mosquito capturing device comprising a screen provided with an opening disposed in the central portion thereof such that the fan motor is not covered by the screen.

It is a further object of the present subject matter to provide a kit for adapting a conventional household fan into a mosquito capturing device comprising a screen provided with a slit disposed in the screen such that a power cord can be extended therethrough.

It is yet a further object of the present subject matter to provide a kit for adapting a conventional household fan into a mosquito capturing device comprising a screen element which can be removably affixed to the rear side of the fan and an LED light source which also can be removably affixed to the rear side of the fan.

It is still a further object of the present subject matter to provide a kit for adapting a conventional household fan having a non-metal (non-magnetic) outer housing into a mosquito capturing device comprising a screen element and an LED light source, both of which can be removably affixed to the rear side of the fan, by Velcro™ fastening means, clip fasteners or adhesive fasteners.

It is an additional object of the present subject matter to provide a kit for adapting a conventional household fan into a mosquito capturing device comprising a screen element removably attachable to the fan a battery-powered LED light removably attached to the fan, the LED light being an attractant for mosquitoes.

It is an additional object of the present invention to provide a kit for adapting a conventional household fan into a mosquito capturing device comprising a screen element and an LED light source, both of which can be removably attached to any standard circular fan or box fan.

It is another object of the present invention to provide a kit for adapting a conventional household fan into a device for capture mosquitoes, gnats, and other weak flying insects.

It is still another object of the present invention to provide a kit for adapting a conventional household fan into a mosquito capturing device comprising a screen element and an LED light source, both removably attached to the rear side of the fan, which traps mosquitoes and other weak flying insects onto the screen, and wherein the trapped insects can be sprayed with rubbing alcohol and brushed off the screen.

These and other objects of the present subject matter are accomplished by providing

### BRIEF DESCRIPTION OF DRAWINGS

FIG. 1 is a plan view of the mosquito catching device kit of the present subject matter.

FIG. 2 is a perspective view of the mosquito catching device kit of the present subject matter and a household circular fan.

FIG. 3 is a top perspective view of the mosquito catching device kit of the present subject matter having the kit elements installed on a household circular fan.

FIG. 4 is a rear perspective view of the mosquito catching device kit of the present subject matter installed onto a household box fan.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “screen element”, “circular screen”, “screen”, and similar terms may be used throughout the specification and it is to be understood that such terms are interchangeable and all refer to the screen element of the present subject matter.

It also should be understood that the term “mosquitoes” includes any small flying insect including gnats and other weak flying insects, and is not limited solely to mosquitoes.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The present subject matter is directed kit for converting or removably adapting a conventional household fan into a mosquito catching device for the purpose of drawing mosquitoes into the fan by the rotating movement of the fan blades and onto a removably attached screen affixed to rear side of the fan. Once the mosquitoes are captured onto the screen, they are unable to escape off the screens as motion of the fan blades keep the mosquitoes trapped on the screen. Also removably affixed to the rear side of fan is an LED light source which is clipped, magnetically attached, or otherwise fastened to the fan housing. The LED light source provides an additional lure or attractant to the mosquitoes. When the fan is activated, a lot of air is moved, trapping mosquitoes onto the screen. The screen and the mosquitoes on the screen can be sprayed or spritzed with rubbing alcohol and brushed off the screen, can be scraped with a squeegee type device, or can be cleaned easily by using a soft bristle brush to remove the mosquitoes without removing the screen. In an alternate embodiment, the screen can be detached from the rear side of the fan, folded. or rolled up, and disposed. A new screen thereafter can be removably attached to the rear side of the fan.

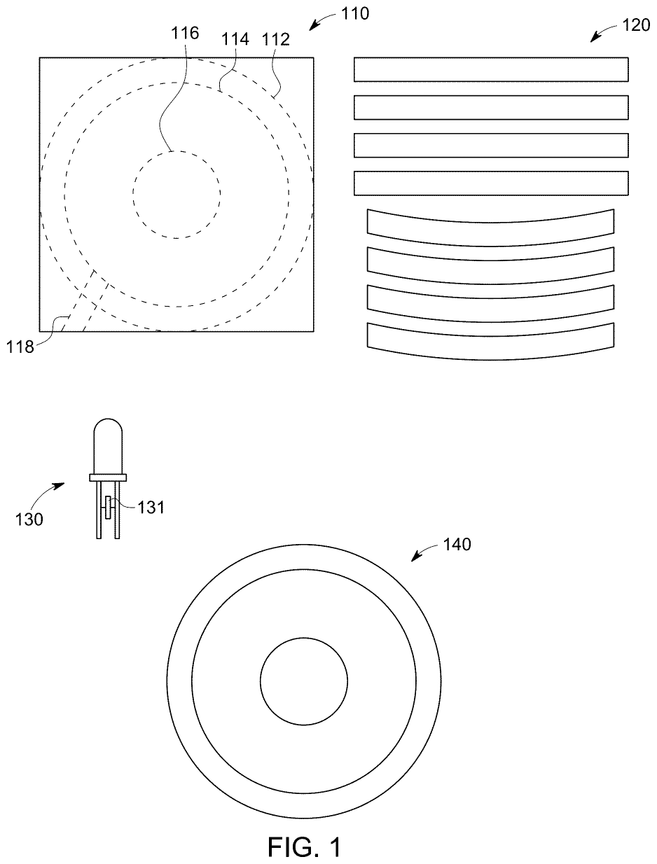

As shown in FIG. 1, the mosquito catching device kit of the present subject matter comprises a screen element 110, magnetic fastening strips 120, and a light source 130, preferably an LED light source. The screen element 110 can be provided as a square sheet of screen material with several indicia or markings to accommodate different sizes and types of household fans. For example, the square sheet can be sufficient sized to fit a conventionally household box fan. The square sheet element 110 can be provided with markings outlining various configurations that can be used as a guide for the user to cut the screen element to the desired shape and size. For example, the screen can be cut for use with a twenty-two inch (22″) fan or an eighteen inch (18″) fan. Thus, the screen element can be cut into a circular shape to be used with both conventional household circular fans and circular oscillating fans. A center circular outline marking is provided which can be cut out such that the screen element can be fitted around a fan motor extending from the fan housing. Another marking on the screen element can be provided to cut a slit for accommodating an electric power cord.

Referring now to FIG. 1, the screen element 110 included in the kit of the present subject matter can be provided with a 22″ circular marking 112, an 18″ circular marking 114, a central opening marking 116, and a slit marking 118. Of course, it will be obvious to those skilled in the art that the mosquito catching device kit of the present subject matter can comprise a circular screen element, a square screen element, or multiple screen elements of varying diameters and shapes.

Alternately, the mosquito catching device of the present subject matter further can comprise a template 140, such as a paper or cardboard template, having varying sized markings on the template to facilitate cutting the screen element into the desired size and shape. In another alternate embodiment, the kit can comprise pre-cut screen elements of pre-determined size and shape.

The screen element can be any type of commercially available screen currently on the market with a sufficiently small mesh size to prevent small flying insects from passing through the mesh openings. For example, the screen element can be in the form of a fiberglass screen mesh typically used for household screen doors and windows. It will be readily apparent to those skilled in the art that any screen element having a sufficiently small mesh opening will be suitable for use in the present invention.

The kit further comprises fastening means to removably attach the screen element to the rear side of the fan. For fans having a metal housing, the fastening element may be in the form of a plurality of magnetic fastening strips 120 which may be used to magnetically attach the screen element to the fan at selected interval along the edges of the screen. The magnetic strips may be rectangular in shape or may be arched to accommodate to the edge of a circular screen. In an alternate embodiment, the magnetic strips may be in the form of a square magnetic strip or a circular magnetic strip. In another alternate embodiment, the screen element may be provided with a plurality of small magnetic pieces around the edges of a pre-cut screen element, thereby eliminating the requirement for separate magnetic strips. To accommodate fans having plastic or non-magnetic housing, the kit can comprise fastening means to removably attach the screen element to the rear side of the fan. Suitable fastening means include hook and loop fastening means such as Velcro™ strips, clips, or adhesives.

The mosquito catching device kit of the present subject matter further comprises a light source 130, preferably an LED light. The light source can be battery powered, can have a rechargeable battery pack, or can be powered from an electric source.

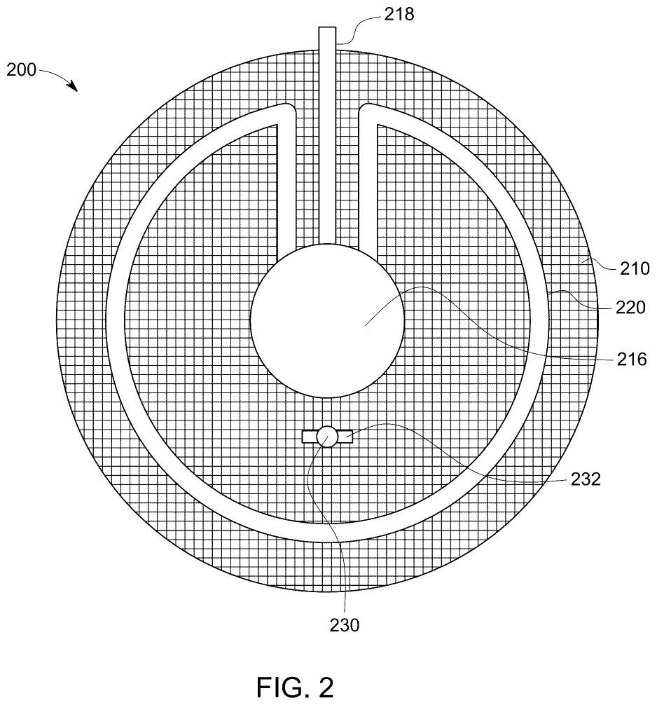

FIG. 2 shows a conventional 22″ circular household fan 200 with the components of the kit available to be removably attached to the rear side of the fan. More particularly, in this embodiment, the mosquito catching device kit comprises a twenty-two-inch (22″) screen element 210, having a central opening 216 to accommodate the central motor fan 206, a circular magnetic strip 220 and an LED light 230 with a clip-on fastener 232.

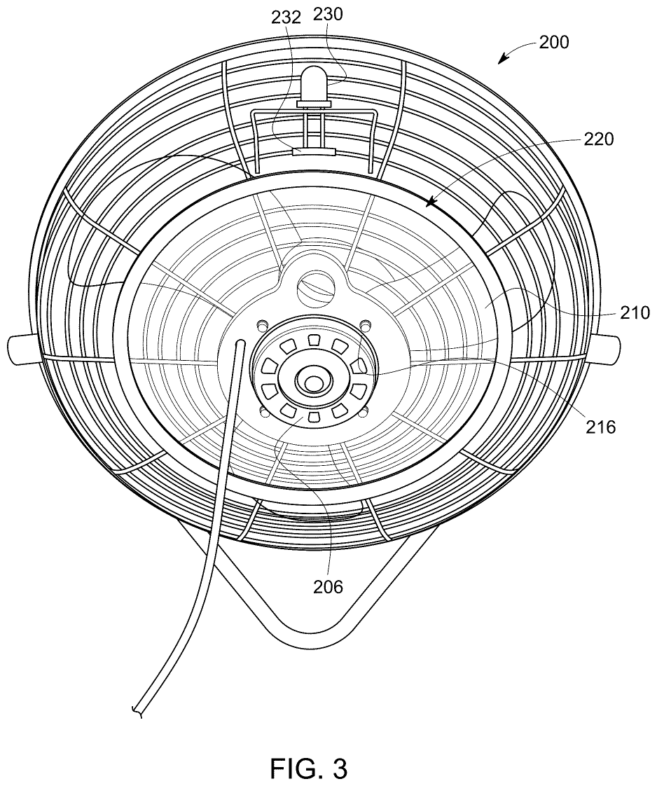

FIG. 3 illustrates one embodiment of the mosquito catching device kit of the present subject matter showing the kit components detachably affixed to a household circular fan 200, comprising a circular screen element 210, a magnetic ring 220 to removably attach the circular screen element 210 to the rear side of a fan, the screen element having a central opening 216 to accommodate a fan motor extending from the fan housing and a slotted opening 218 to accommodate an electric cord, and an LED light 230 which is detachably secured to the rear side of the fan by any suitable means, including, for example, a clip fastener or a magnet affixed to either motor housing or the fan housing.

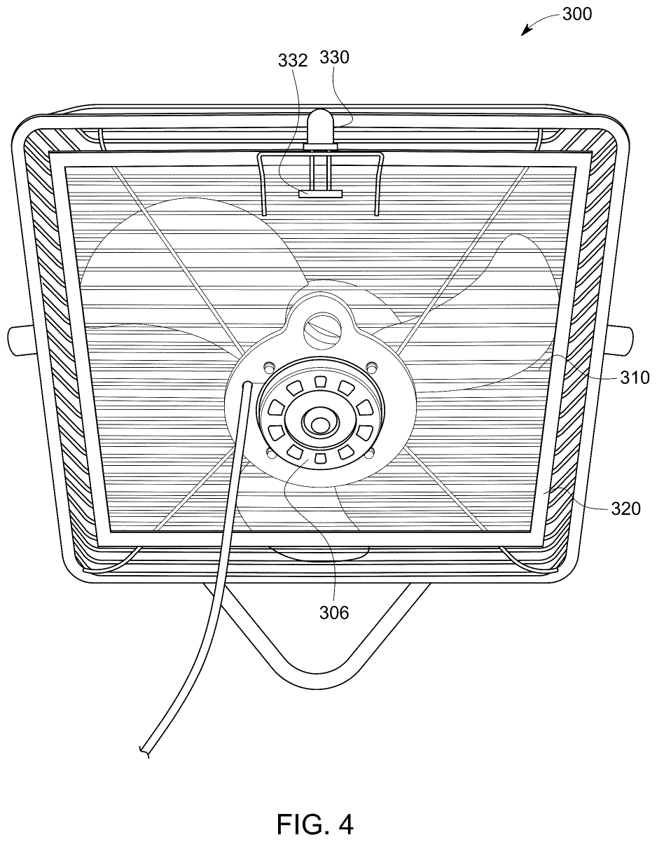

FIG. 4 depicts another embodiment of the mosquito catching device kit of the present subject matter having the components of the mosquito catching device kit installed onto the rear side of a household box fan 300. More specifically, the screen element 310 is removably attached to the fan by a plurality of magnetic strips 320 with the fan motor and fan power cord extending through the central opening 316 of screen element and the LED light 330 removably attached to the fan by clip fastener 332.

It is contemplated to be within the scope of the present invention the mosquito catching device kit of the present subject matter can be manufactured with a fan to provide a complete unit comprising a fan, a magnetically detachably screen element on the rear side of the fan, and an LED light built into the fan unit

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . ”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A mosquito catching device kit comprising:
a. a screen element;
b. a fastening component for removably attaching said screen element to the rear side of a household fan, and
c. an LED light source which can be removably attached to the rear side of a household fan,
wherein, when the household fan is activated, the rotating fan blades move an amount of air sufficient to draw mosquitos into the fan and onto said screen element, thereby catching mosquitoes and trapping the mosquitoes onto said screen element, and wherein said LED light source is an attractant to lure the mosquitoes to the household fan.

2. The mosquito catching device kit in accordance with claim 1, wherein said screen element is in the form of a twenty-two inch (22″) square having indicia markings thereon providing cut lines for a circle having a twenty-two inch (22″) diameter, a circle having an eighteen-inch (18″) diameter, and a center circle sufficiently sized to provide a cut out such that the screen element can be fitted around a fan motor extending from the rear side of a household fan.

3. The mosquito catching device kit in accordance with claim 1, wherein said fastening component for removably attaching said screen element to the rear side of a household fan comprises a plurality of magnetic strips.

4. The mosquito catching device kit in accordance with claim 1, wherein said fastening component for removably attaching said screen element to the rear side of a household fan comprises a magnetic ring.

5. The mosquito catching device kit in accordance with claim 1, wherein said fastening component for removably attaching said screen element to the rear side of a household fan comprises a plurality of hook and loop fastener strips.

6. The mosquito catching device kit in accordance with claim 1, wherein said fastening component for removably attaching said screen element to the rear side of a household fan comprises a plurality of clip fasteners.

7. The mosquito catching device kit in accordance with claim 1, wherein said fastening component for removably attaching said screen element to the rear side of a household fan comprises a detachably adhesive fastener.

8. The mosquito catching device kit in accordance with claim 1, wherein said LED light source is removably attached to the rear side of a household fan by magnetic coupling.

9. The mosquito catching device kit in accordance with claim 1, wherein said LED light source is removably attached to the rear side of a household fan by a clip fastener.

10. The mosquito catching device kit in accordance with claim 1, further comprising a template having a plurality of indicia markings indicating cut lines for a circle having a twenty-two-inch (22″) diameter, a circle having an eighteen-inch (18″) diameter, and a center circle sufficiently sized to provide a cut out such that the screen element can be fitted around a fan motor extending from the rear side of a household fan.

11. The mosquito catching device kit in accordance with claim 1, wherein the fan is a household box fan.

12. The mosquito catching device kit in accordance with claim 1, wherein the fan is a household circular fan.

13. The mosquito catching device kit in accordance with claim 1, where said indicia markings further comprises a slotted cut line.

14. The mosquito catching device kit in accordance with claim 1, further comprising a fan having a first magnetic fastening element on the rear side of said fan for removably fastening said screen element and a second magnetic fastening element for removably attaching said LED light source.
